(19) United States
(12) Patent Application Publication
(10) Pub. No.: US 2008/0013802 A1
(43) Pub. Date: Jan. 17, 2008

(54) METHOD FOR CONTROLLING FUNCTION OF APPLICATION SOFTWARE AND COMPUTER READABLE RECORDING MEDIUM

(75) Inventors: Yi-Hsiu Lee, Taipei (TW); Jui-Shun Pan, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/778,098

(22) Filed: Jul. 16, 2007

(30) Foreign Application Priority Data
Jul. 14, 2006 (TW) 95125795

(51) Int. Cl. G06K 9/00

(52) U.S. Cl. 382/118; 382/103

(57) ABSTRACT

A method for controlling the function of application software and a computer readable recording medium are provided. The method includes the following steps. First, an application software is provided. Afterwards, characteristics of a user are retrieved. Then, characteristics of the user are identified. Finally, according to the result of identification, whether to pause or resume the function of application software is determined. Through the method provided by the present invention, the characteristics of the user are retrieved and then identified, so as to obtain the current status of the user and then automatically determine whether to pause or resume the execution of the function.

### CROSS-REFERENCE TO RELATED APPLICATION

This application claims the priority benefit of Taiwan application serial no. 95125795, filed Jul. 14, 2006. All disclosure of the Taiwan application is incorporated herein by reference.

### BACKGROUND OF THE INVENTION

1. Field of the Invention

The present invention relates to an application program. More particularly, the present invention relates to a method for automatically controlling the function of application software.

2. Description of Related Art

During the execution of application software in a computer, usually, a user has to pause a certain function executed by an application program because of an accident or concerning about something. For example, when watching a video, the user often cannot watch it from beginning to end without any interruption due to some incidents, such as answering a call, going to the toilet, and having a cup of water. When dealing with the accidents, the user has to manually execute the application program to pause the playing of the video, such as using a mouse, a keyboard, and a remote controller. After dealing the accidents, the user still has to manually execute the application program to resume the playing of the video.

However, if the accident is so urgent that the user has no time to execute the application program to pause the playing of the video, after dealing with the accident, the user still has to manually drag the progress bar backwards to move the video back to the episode which the user begins to miss. Apparently, the conventional technology causes inconvenience in executing application software.

### SUMMARY OF THE INVENTION

Accordingly, one objective of the present invention is to provide a method for controlling the function of application software, so as to determine whether to pause or resume the function of the application software according to the characteristics of a user.

Another objective of the present invention is to provide a computer readable recording medium to store the programs with the aforementioned objective.

Based upon the aforementioned and other objectives, the present invention provides a method for controlling the function of application software, which comprises the following steps. An application software is provided, wherein the application software executes at least one function. Next, at least one user characteristic and is retrieved and identified. Finally, whether or not to pause or resume the execution of the function is determined according to the identification result.

According to another embodiment of the present invention, a computer readable recoding medium for storing application software which may be executed in a computer system is provided. The application software is used to execute at least one function and comprises at least an image retrieval unit, an identification unit and a control unit. The image retrieval unit retrieves at least one user characteristic, the identification unit is used to identify the user characteristic, and the control unit determines whether to pause or resume the function according to the identification result obtained by the identification unit.

According to one preferred embodiment of the present invention, the step of identifying the user characteristic comprises analyzing an image of the face or eye portion of the user.

According to one preferred embodiment of the present invention, the step of identifying the user characteristic comprises analyzing a motion of the user.

According to one preferred embodiment of the present invention, the step of identifying the user characteristic comprises analyzing the number of users.

According to one preferred embodiment of the present invention, the step of identifying the user characteristic comprises analyzing the distance between the user and a frame.

According to one preferred embodiment of the present invention, the step of determining whether to pause or resume the function according to the identification result comprises making the application software pause the execution of the function in case of absence of the user in the retrieved image.

According to one preferred embodiment of the present invention, the application software comprises a video player with the function of playing videos.

According to one preferred embodiment of the present invention, the application software comprises a document editor with the function of viewing documents.

According to one preferred embodiment of the present invention, the application software comprises a display manager with the function of presenting a display frame.

Through the method provided by the present invention, the characteristics of the user are retrieved and then identified, so as to obtain the status of the user at that time and then automatically determine whether to pause or resume the execution of the function.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an application of the control application software according to one embodiment of the present invention.

FIG. 2 is an image shot by a camera 120 in FIG. 1.

FIG. 3 is a flow chart of the method for controlling the function of application software according to the first embodiment of the present invention.

FIG. 4 is a flow chart of the method for controlling the function of the application software according to the second embodiment of the present invention.

FIG. 5A is an image shot by the camera 120 in FIG. 1.

FIG. 5B is another image shot by the camera 120 in FIG. 1.

FIG. 6 is a flow chart of the method for controlling the function of the application software according to the third embodiment of the present invention.

FIG. 7 is an image shot by the camera 120 in FIG. 1.

FIG. 8 is a flow chart of the method for controlling the function of the application software according to the fourth embodiment of the present invention.

FIG. 9 is a schematic view of an application of the control application software according to another embodiment of the present invention.

FIG. 10 shows an image shot by a camera 120 in FIG. 9.

FIG. 11 is a flow chart of the method for controlling the function of application software according to the fifth embodiment of the present invention.

FIG. 12 is a flow chart of the method for controlling the function of the application software according to the sixth embodiment of the present invention.

FIG. 13 is a schematic view of an application of the control application software according to yet another embodiment of the present invention.

FIG. 14 is an image shot by the camera 12 in FIG. 13.

FIG. 15 is a block diagram of the control application software according to the seventh embodiment of the present invention.

### DESCRIPTION OF EMBODIMENTS

### The First Embodiment

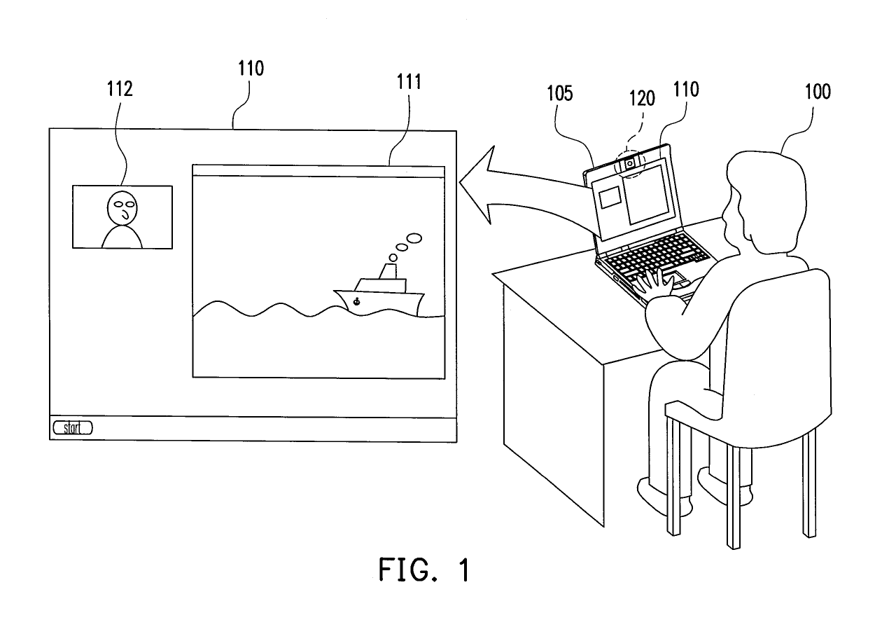

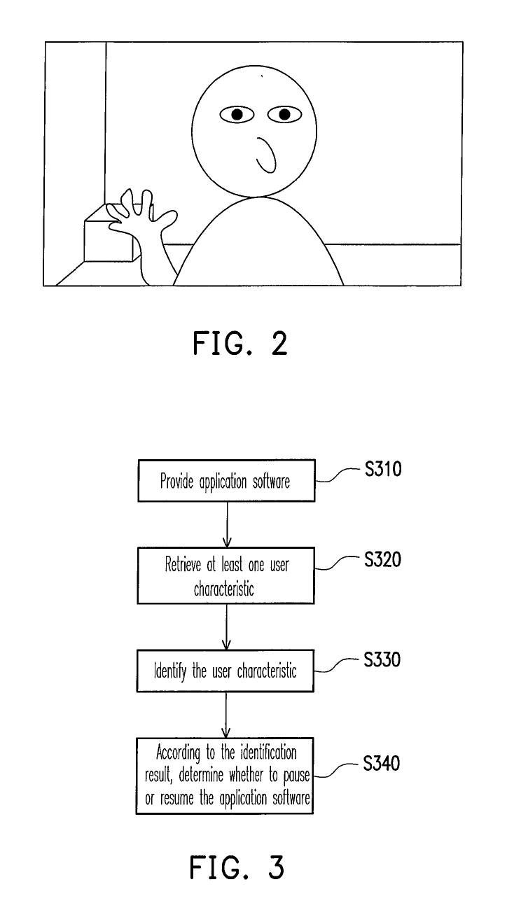

FIG. 1 is a schematic view of an application of the control application software according to one embodiment of the present invention, and FIG. 2 is an image shot by a camera 120 in FIG. 1. Referring to FIGS. 1 and 2, a user 100 is shown watching a display frame 110 through a computer 105, wherein the computer 105 executes a video player to play the video through a playing window 111. A frame shot by a camera 120 is displayed in a shooting window 112. In the present invention, the user characteristics which are shot are analyzed to determine the motion of the corresponding application software, such as a control video player, so as to determine whether to automatically pause or resume the application software. The application software may be a document editor, a display manager and other programs, and the function of the application software may be viewing documents, display frames, and so on.

For example, when executing the video player, an image shot by the camera 120 is shown in FIG. 2, and is displayed in the display frame 110. It may be known from the display frame that the user is watching the frame 110 which is being played, and is beckoning. The application software of the present invention determines whether the user is watching the frame based upon the frame shot by the camera 120, and then makes a corresponding response.

Next, the function and method for automatically pausing and resuming the application software of the present embodiment are illustrated below. FIG. 3 is a flow chart of the method for controlling the function of application software according to the first embodiment of the present invention. Referring to FIG. 3, in Step S310, the application software is provided to execute at least one function. In the present embodiment, the application software may be a video player for executing the function such as playing a video. In Step S320, at least one user characteristic is retrieved. In the present embodiment, the user 100 is shot by the camera 120 in FIG. 1 and then the image is displayed in the shooting window 112 of the display frame 110, such that the user characteristics are retrieved from the image.

The user characteristic may be the characteristic of the image of the user's face, the characteristic of the user's eye, the characteristic of the user's motion, and so on. The retrieved user characteristic is provided to Step S330 to be further identified. The step of retrieving and identifying the user characteristic may be realized by those skilled in the art by using any technology. For example, Mr. Jon Wetzel, in the Context Aware Computing Group of the MIT Media Lab, has disclosed a face detecting technology in 2005. Mr. Jon Wetzel has revealed the source code of the face detecting technology for the public's use.

Then, in Step S340, it is determined whether or not to pause or resume the function executed by the application software according to the identification result in Step S330. For example, when the user 100 leaves the seat, or takes off the eyes of the user characteristic from the display (i.e. user 100 does not focus the attention on the video), the application software will automatically pause the video and freeze the frame of the playing window 111, and will not resume the playing of the video unless the user is back to the seat or moves back the eyes of the user characteristic to the display (i.e. moves the line of sight back to the playing window 111). Therefore, in the present embodiment, it may be automatically determined whether to pause or resume the execution of the function through detection of the current state of the user.

In order to facilitate the illustration, several following embodiments taking “playing a video” as an example of the present invention. The application software includes a video player with the function of playing a video. The second embodiment describes the implementation process when the user does not focus attention on the video.

### The Second Embodiment

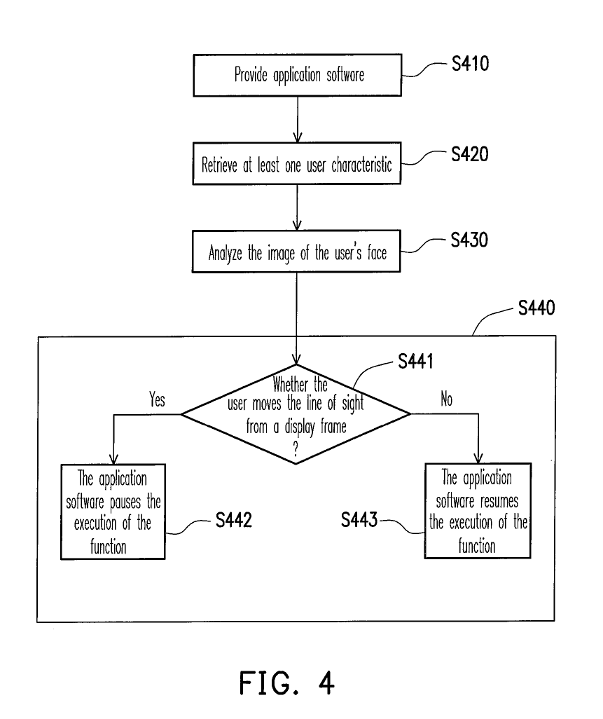

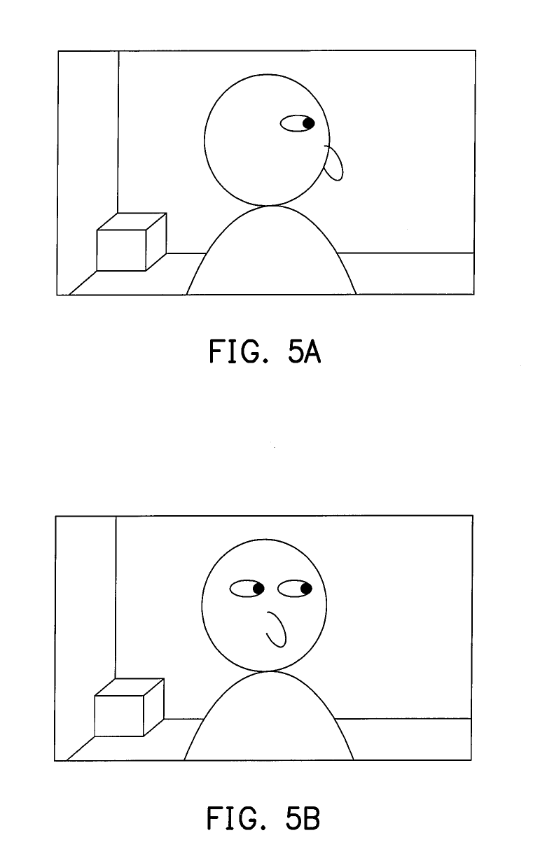

FIG. 4 is a flow chart of the method for controlling the function of the application software according to the second embodiment of the present invention, FIG. 5A is an image shot by the camera 120 in FIG. 1, and FIG. 5B is another image shot by the camera 120 in FIG. 1. In the present embodiment, Steps S410 and S420 are the same as Steps S310 and S320 in FIG. 3 and therefore will not be repeated. Referring to FIGS. 1 and 4, in the present embodiment, in Step S420, the camera 120 is used to shoot the face of the user 100 and obtain an image, so as to retrieve the user characteristic. The retrieved user characteristic is provided to Step S430 to be further identified. Step S430 in the present embodiment may employ the face detecting technology disclosed by Mr. Jon Wetzel to analyze the image of the user's face.

In Step S440, it is determined whether to pause or resume the function executed by the application software according to the identification result of Step S430. Step S440 comprises sub-steps S441, S442, and S443. In the sub-step S441, it is determined whether the user 100 focuses attention on the playing video, i.e., on the playing window 111 of the display frame 110. When the user 100 turns his/her face elsewhere, as shown in FIG. 5A, and does not watch the playing video, the application software automatically pauses the playing of the video and freezes the frame in the playing window 111, as shown in Step S442. When the eyes of the user characteristic are moved to the display (i.e. the user moves the line of sight to the display frame 110), as shown in FIG. 2, the application software automatically resumes the playing of the video from where the video is paused (Step S443).

In Step S430 of the present embodiment, the image of the user's eye is also analyzed. When the eyes of the user characteristic are taken off the display (i.e. the user leaves the line of sight from the display frame 110), but still faces the display frame 110, as shown in FIG. 5B, in the sub-step S441, it may be determined that the user 100 does not focus attention on the playing video. Therefore, the application software automatically pauses the playing of the video and freezes the frame in the playing window 111 (Step S442). When the eyes of the user characteristic are moved back the display (i.e. the user moves the line of sight onto the display frame 110) (as shown in FIG. 2), the application software automatically resumes the playing of the video from where the video is paused (Step S443).

In the present embodiment, the video is controlled to be played or paused through the identification of the user characteristic, such as whether the user is watching the display frame or faces the display frame. In some embodiments of the present invention, the video may be controlled to be played or paused by using default motions.

### The Third Embodiment

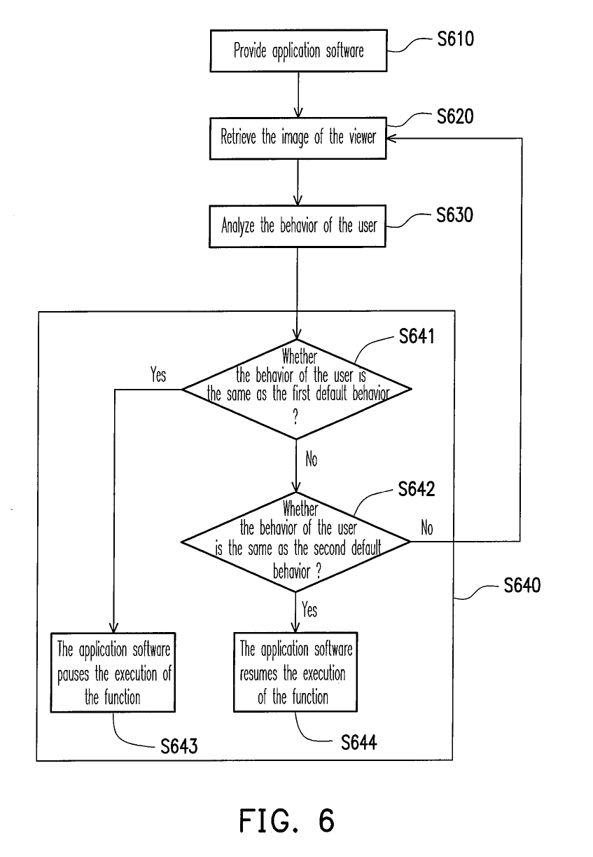

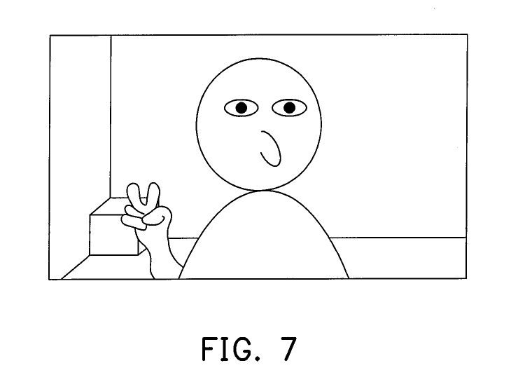

FIG. 6 is a flow chart of the method for controlling the function of the application software according to the third embodiment of the present invention, and FIG. 7 is an image shot by the camera 120 in FIG. 1. In the present embodiment, Steps S610 and S620 are the same as Steps S310 and S320 in FIG. 3 and therefore will not be repeated. Referring to FIGS. 1 and 6, in the present embodiment, in Step S620, the camera 120 is used to shoot the motion of the user 100, so as to retrieve the user characteristic. The retrieved user characteristic is provided to Step S630 to be analyzed, i.e., to be identified. Step S630 may be implemented by any technology familiar to those skilled in the art.

In Step S640, it is determined whether or not to pause or resume the function executed by the application software according to the identification result of Step S630. Step S640 comprises the sub-steps S641, S642, S643, and S644. In the sub-step S641, it is determined whether or not the motion of the user 100 is the same as a first default motion. Herein, it is assumed that the first default motion is spreading out the five fingers of the right hand, as shown in FIG. 2. When the motion of the user 100 is the same as the first default motion, the application software automatically pauses the displaying of the video and freezes the frame in the display window 111 (the sub-step S643); otherwise, the sub-step S642 is proceeded. In the sub-step S642, it is determined that the motion of the user 100 is the same as a second default motion. Herein, it is assumed that the second default motion is raising the right hand to make a peace sign, as shown in FIG. 7. When the motion of the user 100 is the same as the second default motion, the application software automatically plays the video from where the video is paused (Step S644); otherwise, Step S620 will be repeated.

### The Fourth Embodiment

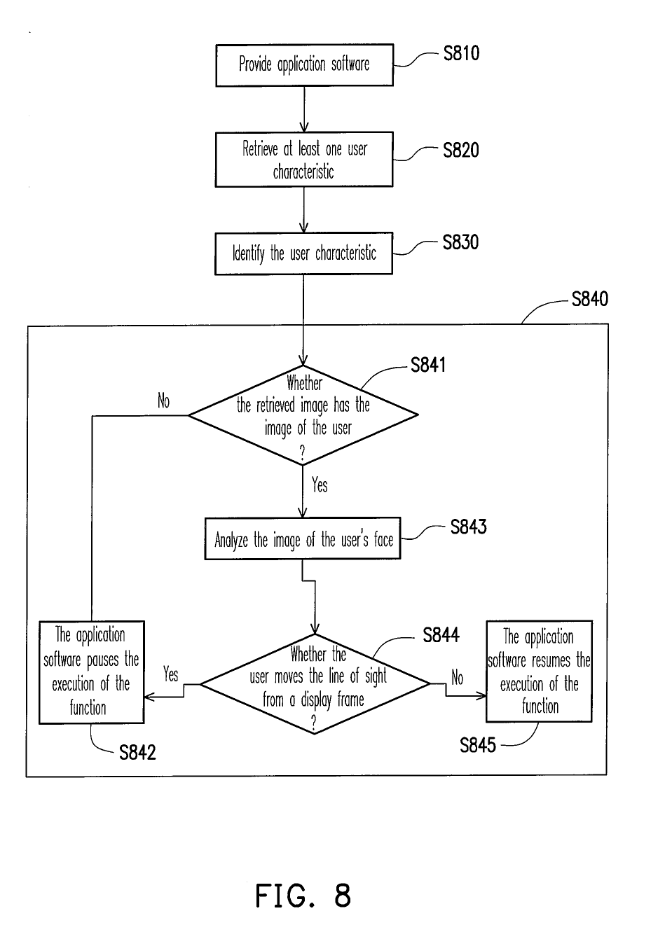

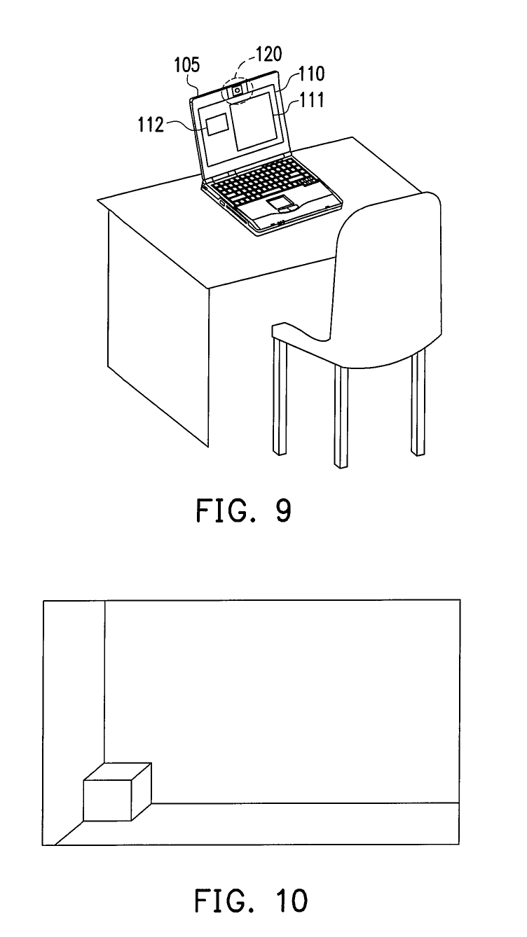

In the present embodiment, the state that the user is detected to leave the seat (i.e., the shooting window 112 does not display the image of the user) is illustrated. FIG. 8 is a flow chart of the method for controlling the function of the application software according to the fourth embodiment of the present invention, FIG. 9 is a schematic view of another circumstance for using the control application software according to one embodiment of the present invention, and FIG. 10 shows an image shot by a camera 120 in FIG. 9. In the present embodiment, Steps S810, S820, and S830 are the same as Steps S310, S320, and S330 in FIG. 3, and will not be described any more.

Referring to FIGS. 8 and 9, In Step S840, it is determined whether or not to pause or resume the function executed by the application software according to the identification result of Step S830. Step S840 comprises the sub-steps S841, S842, S843, S844, and S845. In Step S841, it is determined whether or not a retrieved image comprises the image of the user. If the frame (i.e., the shooting window) shot by the camera 120 has no image of the user, as shown in FIG. 10, the application software automatically pauses the playing of the video and freezes the frame in the playing window 111 (the sub-step S842). If the frame has the image of the user, the sub-step S843 is proceeded. In the sub-step S843, the image of the user's face 100 is analyzed. In the sub-steps S842, S844, and S845, it is determined whether the user concentrates on the playing video. The sub-steps S842, S844, and S845 are the same as the sub-steps S442, S441, and S443 in FIG. 4 and therefore will not be repeated.

In some embodiments, for example, with a view to safety, the number of users is limited when reading confidential documents.

### The Fifth Embodiment

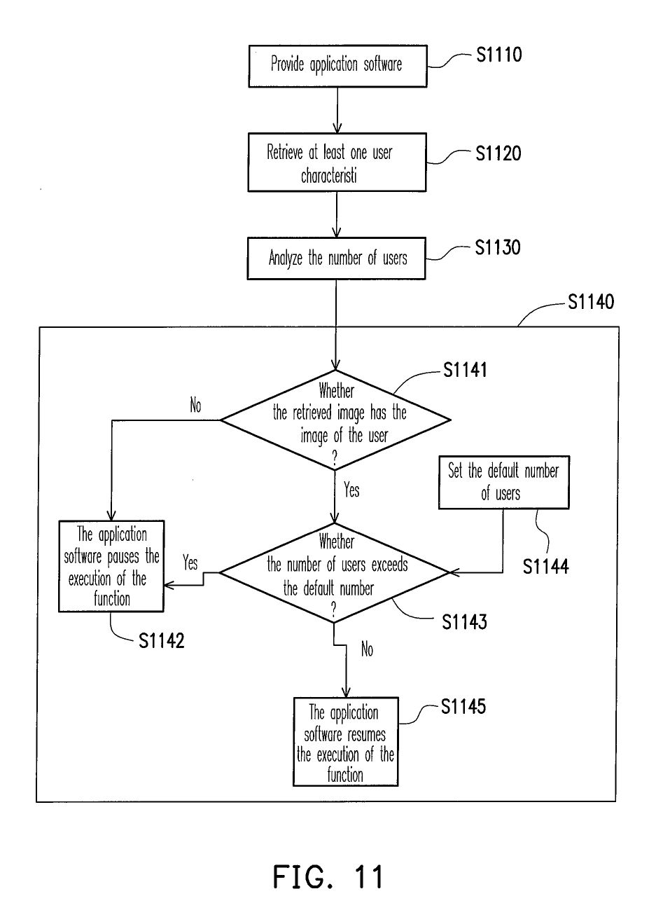

FIG. 11 is a flow chart of the method for controlling the function of application software according to the fifth embodiment of the present invention. Referring to FIG. 11, in the present embodiment, Steps S1110 and S1120 are the same as Steps S310 and S320 in FIG. 3. In Step S1130 of the present embodiment, the number of users is analyzed. Subsequently, according to the identification result in Step S1130, it is determined whether or not to pause or resume the function executed by the application software (Step S1140). Step S1140 comprises sub-steps (S1141-S1145).

In the sub-step S1141, it is determined whether or not the retrieved image has the image of the user. If the retrieved image has no image of the user, the application software pauses the execution of the function (Step S1142). If the retrieved image has the image of the user, it is further determined whether the number of the users exceeds a default value. Of course, the default value of the number of user is decided by the user in advance (Step S1144). After comparing the number of the users with the default value, if the number of the users does not exceed the default value, Step S1145 is performed to let the application software resume executing the function, such as displaying an confidential document; otherwise, Step S1142 is performed to make the application software pause the function, such as hiding an confidential document.

Additionally, in some embodiments of the present invention, a distance is set. The function of the application software cannot be maintained unless the distance between the user and the display frame is larger than the set distance, so as to protect the vision.

### The Sixth Embodiment

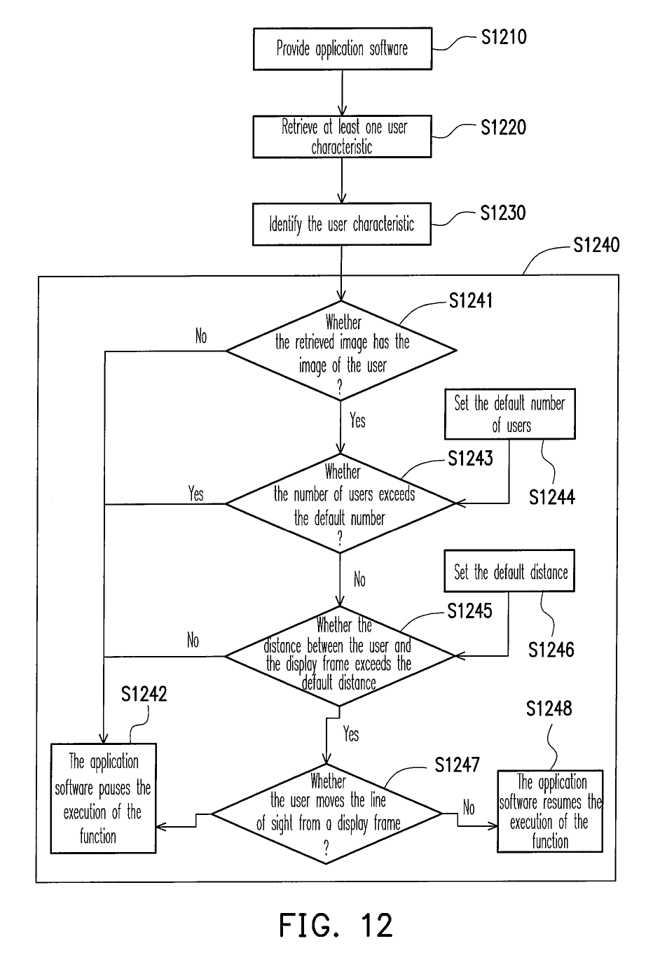

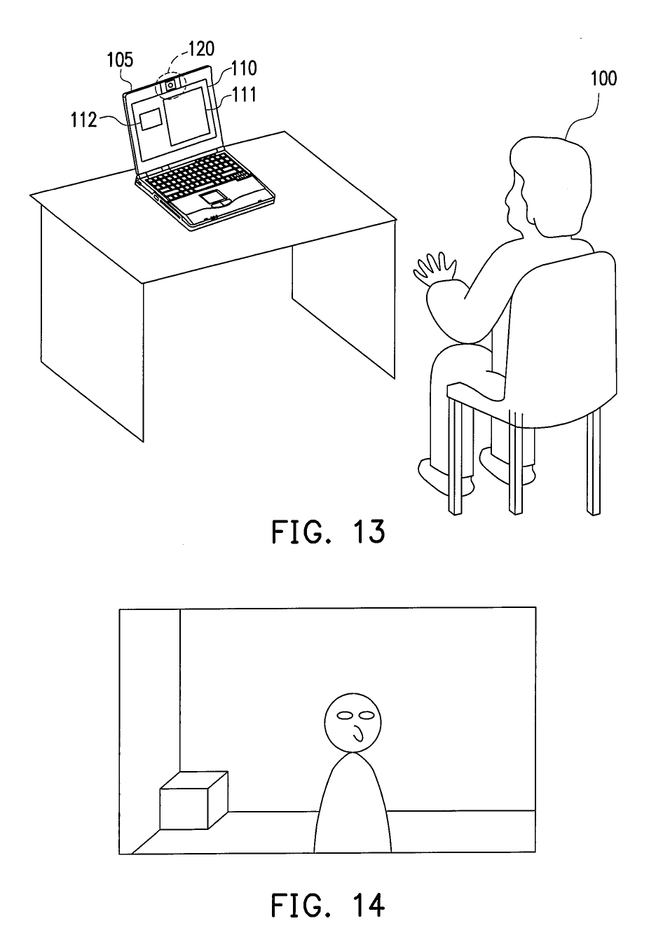

FIG. 12 is a flow chart of the method for controlling the function of the application software according to the sixth embodiment of the present invention. FIG. 13 is a schematic view of still another circumstance for using control application software according the present invention. FIG. 14 is an image shot by the camera 12 in FIG. 13. Referring to FIGS. 12 and 13, Steps S1210, S1220, and S1230 in the present embodiment are similar to Steps S310, S320, and S330 in FIG. 3. In the present embodiment, in Step S1240, it is determined whether or not to pause or resume the function executed by the application software according to the identification result in Step S1230, wherein Steps S1241-S1248 are sub-steps of Step S1240.

Steps S1241-S1244 in the present embodiment are similar to Steps S1141-S1144 in FIG. 11 and therefore will not repeated. In Step S1245, it is determined whether or not the distance between the user 100 and the display frame 110 exceeds the default distance. In the present embodiment, in Step S1230, the distance between the user 100 and the display frame 110 is determined through analyzing the proportion of the retrieved image, as shown in FIG. 14. The default distance may be decided by the user in advance (Step S1246). In order to protect the vision, if the distance between the user 100 and the display frame 110 does not exceed the default distance, Step S1242 is proceeded to make the application software pause the function, such as pause the playing of the video. If the distance between the user 100 and the display frame 110 exceeds the default distance, it is further determined whether the line of sight of the user leaves the display frame (Step S1247), so as to determine whether to pause the function executed by the application software (Step S1242), or resume the function executed by the application software (Step S1248). Since too close and too far distance both influence the vision when watching the display frame, those skilled in the art may amend the embodiment based upon the spirit of the present invention and the teaching of the present embodiment. For example, when the distance is too close, the playing of the video is paused and will not resume unless the user keeps a suitable distance from the display frame; and when the distance is too far, it is regarded that the user has left, and the playing of the video is paused and will not be resumed unless the user keeps a suitable distance from the display frame.

### The Seventh Embodiment

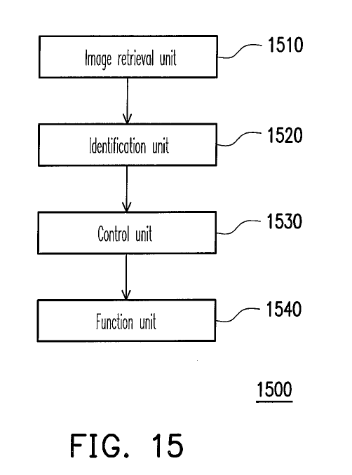

FIG. 15 is a block diagram of the control application software 1500 according to the seventh embodiment of the present invention. The application software 1500 is used to execute at least one function. Referring to FIG. 15, the application software 1500 comprises an image retrieval unit 1510, an identification unit 1520, and a control unit 1530. The image retrieval unit 1510 is used to retrieve at least one user characteristic. The identification unit 1520 is used to identify the user characteristic. The control unit 1530 is used to determine whether to pause or resume a function unit 1540 of the application program according to the identification result of the identification unit 1520.

The user characteristics identified by the identification unit 1520 includes analyzing the face, eye portion, and motion of the user, the number of users, and the distance between the user and the frame. The analysis result is transmitted to the control unit 1530. The control unit 1530 controls the function unit 1540 according to the identification result of the identification unit 1520. For example, when the user moves the line of sight from the display frame, the application software 1500 pauses the execution of the function unit 1540. The functions of the control unit 1530 of the present embodiment and the sorts and functions of the application software may be implemented with reference to the above-mentioned embodiment and will not be described any more.

In view of the above, the method for controlling application software disclosed in the present employs a camera to retrieve the image of a user, and has the following advantages after analyzing its characteristics:

1. When executing a computer program, such as watching a video, the user need not pause the playing of the video when some incidents occur or he/she cannot focus the attention on the video, such as answering a call, going to a toilet, and having a cup of water. After dealing with the accidents, the user can continue watching the video without dragging the progress bar backwards to move the video back to the episode which the user begins to miss and resuming the playing of the video by means of a manual mode.

2. The number of the users may have an upper limit. In some special situations, such as reading emails or confidential documents, and holding video conferences, when the application software detects that the number of users exceed the upper limit, a current application program, such as a video player and a document editor, is paused, thus protecting the privacy of the users.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for controlling the function of application software, comprising:
providing an application software, wherein the application software executes at least one function and showing the application software on a display;
retrieving at least one user characteristic;
identifying the user characteristic; and
controlling the function according to a result of the step of identifying.

2. The method for controlling the function of application software as claimed in claim 1, wherein the step of identifying comprises analyzing a face image of the user characteristic.

3. The method for controlling the function of application software as claimed in claim 1, wherein the step of identifying comprises eyes of the user characteristic being taken off the display and the step of controlling comprises pausing the function executed.

4. The method for controlling the function of application software as claimed in claim 3, wherein the step of identifying comprises eyes of the user characteristic being moved back the display and the step of controlling comprises resuming the function executed.

5. The method for controlling the function of application software as claimed in claim 1, wherein the step of identifying comprises analyzing an eye portion image of the user characteristic, and the step of controlling comprises:
pausing the function executed when eyes of the user characteristic are taken off the display; and
resuming the function executed when eyes of the user characteristic are moved back the display.

6. The method for controlling the function of application software as claimed in claim 1, wherein the step of identifying comprises analyzing a motion of the user characteristic and the step of controlling comprises:
pausing the function executed when the motion of the user characteristic is the same as a first default motion; and
resuming the function executed when the motion of the user characteristic is the same as a second default motion.

7. The method for controlling the function of application software as claimed in claim 1, further comprises providing a default number of users, wherein the step of identifying comprises analyzing a number of the users and the step of controlling comprises:
comparing the number of the users with the default number; and
determining whether to pause or resume the function according to a result of the step of comparing.

8. The method for controlling the function of application software as claimed in claim 1, further comprises providing a default value of distance, wherein the step of identifying comprises analyzing a distance between the user characteristic and the display, and comparing the distance with the default value of the distance; and the step of controlling comprises:
determining whether to pause or resume the function according to a result of the step of comparing.

9. The method for controlling the function of application software as claimed in claim 1, wherein the application software comprises a video player, and the function comprises playing a video.

10. The method for controlling the function of application software as claimed in claim 1, wherein the application software comprises a document editor and the function comprises viewing a document.

11. The method for controlling the function of application software as claimed in claim 1, wherein the application software comprises a display manager and the function comprises presenting a display frame.

12. A computer readable recording medium, for storing an application software capable of being executed in a computer system, wherein the application is used to execute at least one function and comprises:
an image retrieval unit, for retrieving at least one user characteristic;
an identification unit, for identifying the user characteristic; and
a control unit, for determining whether to pause or resume the function according to an identification result of the identification unit.

13. The computer readable recording medium as claimed in claim 12, wherein the application software comprises a video player, and the function comprises playing a video.

14. The computer readable recording medium as claimed in claim 12, wherein the application software comprises a document editor and the function comprises viewing a document.

15. The computer readable recording medium as claimed in claim 12, wherein the application software comprises a display manager and the function comprises presenting a display frame.
